(19) United States
(12) Patent Application Publication
(10) Pub. No.: US 2025/0373346 A1
(43) Pub. Date: Dec. 4, 2025

(54) ADJUSTABLE ATTENUATION TEST SYSTEM AND OPERATION METHOD THEREOF

(71) Applicant: ASMedia Technology Inc., New Taipei City (TW)

(72) Inventors: Yih Fan Chang, New Taipei City (TW); Pao kuei Chen, New Taipei City (TW)

(73) Assignee: ASMedia Technology Inc., New Taipei City (TW)

(21) Appl. No.: 18/822,251

(22) Filed: Sep. 1, 2024

(30) Foreign Application Priority Data
May 31, 2024 (TW) 113120169

(51) Int. Cl. H04B 17/16; H04B 17/10

(52) U.S. Cl. CPC H04B 17/16; H04B 17/102

(57) ABSTRACT

An adjustable attenuation test system and an operation method thereof are provided. The attenuation test system includes: an adjustable attenuation circuit, a control circuit, and a device under test. The device under test is connected to the adjustable attenuation circuit and the control circuit. The device under test includes a transmitting end and a receiving end. The adjustable attenuation circuit has a variable impedance. When the device under test performs a built-in self-test (BIST), the device under test outputs a test pattern data from the transmitting end. The device under test generates a determining result based on the test pattern received by the receiving end. The control circuit receives the determining result, and generates and outputs an attenuation control signal to the adjustable attenuation circuit based on the determining result. The adjustable attenuation adjusts the variable impedance based on the attenuation control signal.

### CROSS-REFERENCE TO RELATED APPLICATION

This application claims the priority benefit of Taiwan application serial no. 113120169, filed on May 31, 2024. The entirety of the above-mentioned patent application is hereby incorporated by reference herein and made a part of this specification.

### BACKGROUND

### Technical Field

The disclosure relates to a high-speed automated test equipment (ATE), and in particular to an adjustable attenuation test system and an operation method thereof.

### Description of Related Art

Current high-speed serial transmission circuits include a variety of specifications, such as PCIe Gen 5 and USB 4.0, which use eye diagram packets of high-speed signals to transmit data. For example, USB 4.0 can support multiple specifications with different attenuations, which means that the USB 4.0 connector can be used to connect a variety of peripheral devices. The peripheral devices also adjust the frequency according to the applicable data bandwidth. Therefore, under the high-speed transmission architecture, different frequencies produce different attenuation, and the mass production test environment needs to be adjusted according to different frequencies.

In semiconductor mass production, a high-speed ATE test environment is used. During the test process, different electrical environments need to be used to meet different attenuations. The current ATE test environment uses a fixed and precise design to maintain a reliable electrical environment. However, this approach is difficult to adapt to different attenuation requirements and requires repeated testing to determine the correctness of the test results, which consumes a lot of testing time.

### SUMMARY

In view of this, the disclosure provides an adjustable attenuation test system and an operation method thereof, which may adjust an attenuation capability by changing a resistance value of a circuit path to meet various testing requirements.

The adjustable attenuation test system of the disclosure includes an adjustable attenuation circuit, a control circuit, and a device under test. The device under test is connected to the adjustable attenuation circuit and the control circuit. The device under test includes a transmitting end and a receiving end. The adjustable variable attenuation circuit has a variable impedance. When the device under test performs a built-in self-test, the device under test outputs a test pattern data from the transmitting end. The device under test generates a determining result based on the test pattern data received from the receiving end. The control circuit receives the determining result, and generates and outputs an attenuation control signal to the adjustable attenuation circuit based on the determining result. The adjustable variable attenuation circuit adjusts the variable impedance based on the attenuation control signal.

The operation method of the adjustable attenuation test system of the disclosure includes: when the device under test executes the built-in self-test, the test pattern data is output from the transmitting end of the device under test; the device under test generates the determining result based on the test pattern data received from the receiving end; the determining result is received through the control circuit, and the attenuation control signal is generated and output to the adjustable attenuation circuit based on the determining result; and the variable impedance is adjusted based on the attenuation control signal through the adjustable attenuation circuit.

Based on the above, the adjustable attenuation test system and the operation method thereof provided by the disclosure may be based on a lookback mechanism and generate the determining result based on the received test pattern data to determine whether the variable impedance of the adjustable attenuation circuit needs to be adjusted. Accordingly, the adjustable attenuation testing system and the operation method provided by the disclosure may be adapted to the attenuation requirements of different devices under test through the manner of adjusting the variable impedance, thereby providing a reliable electrical testing environment.

To make the aforementioned more comprehensible, several embodiments accompanied with drawings are described in detail as follows.

### BRIEF DESCRIPTION OF THE DRAWINGS

FIG. 1 is a schematic diagram of an adjustable attenuation test system according to an embodiment of the disclosure.

FIG. 2 is a schematic diagram of an adjustable T-shaped attenuator according to an embodiment of the disclosure.

FIG. 3 is a schematic diagram of an adjustable attenuation circuit according to an embodiment of the disclosure.

FIG. 4 is a schematic diagram of an adjustable attenuation circuit according to another embodiment of the disclosure.

FIG. 5 is a flow chart illustrating an operation method of an adjustable attenuation test system according to an embodiment of the disclosure.

### DESCRIPTION OF THE EMBODIMENTS

Some embodiments of the disclosure will be described in detail below with reference to the accompanying drawings. Reference numerals quoted in the following description will be regarded as the same or similar components when the same reference numerals appear in different drawings. The embodiments are merely a part of the disclosure and do not disclose all possible implementations of the disclosure. More precisely, the embodiments are only examples in the claims of the disclosure.

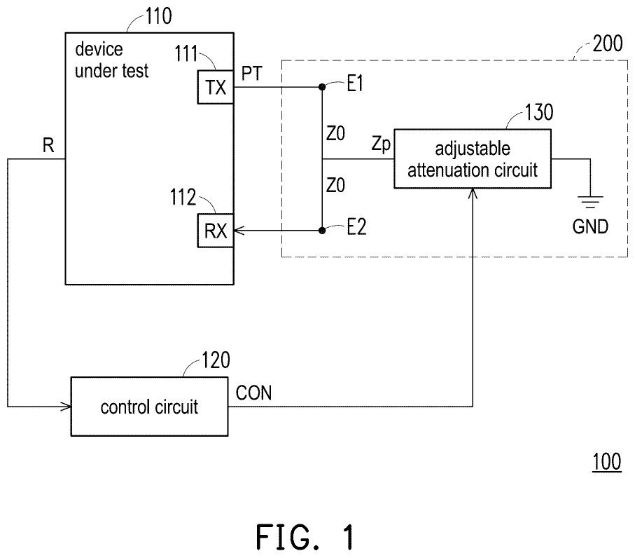

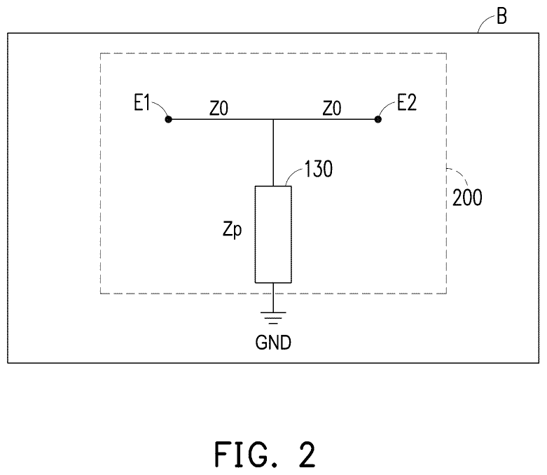

FIG. 1 is a schematic diagram of an adjustable attenuation test system according to an embodiment of the disclosure. FIG. 2 is a schematic diagram of an adjustable T-shaped attenuator according to an embodiment of the disclosure. Referring to FIG. 1 and FIG. 2, a test system 100 includes a device under test 110, a control circuit 120, and an adjustable attenuation circuit 130. The device under test 110 includes a transmitting end 111 and a receiving end 112. The device under test 110 is connected to the control circuit 120 and the adjustable attenuation circuit 130. The control circuit 120 may be, for example, any programmable digital circuit well known to those skilled in the art. The adjustable attenuation circuit 130 is connected to a ground end GND. The adjustable attenuation circuit 130 has a variable impedance Zp.

In this embodiment, the adjustable attenuation circuit 130, a signal input end E1, and a signal output end E2 form an adjustable T-shaped attenuator 200. The adjustable T-shaped attenuator 200 may be disposed on a substrate B, for example. The substrate B may be, for example, a circuit board with a characteristic impedance Z0 or various types of low-loss boards with the characteristic impedance Z0. The signal input end E1 is connected to the transmitting end 111 of the device under test 110, and the signal output end E2 is connected to the receiving end 112 of the device under test 110.

Generally speaking, resistance values of resistors used in conventional T-shape attenuators are fixed, which is difficult to be adapted to various attenuation requirements. In addition, since high-speed signal transmission is easily affected by a parasitic capacitance and an inductance effect of transmission circuits, the disclosure provides the adjustable T-shaped attenuator 200. The adjustable T-shaped attenuator 200 utilizes the characteristic impedance Z0 of the substrate B to replace the impedances at both ends of the conventional T-type attenuator, so that the two ends of the adjustable T-type attenuator 200 do not need to be provided with additional resistors like the conventional T-type attenuator, thereby reducing the complexity of the adjustable T-type attenuator 200. In addition, the adjustable T-shaped attenuator 200 of the disclosure may also use the variable impedance Zp of the adjustable attenuation circuit 130 to be adapted to the attenuation requirements required by various devices under test 110 and provide diverse and reliable electrical testing environments.

When the device under test 110 performs a built-in self-test (BIST), the device under test 110 may output a test pattern data PT from the transmitting end 111. In this embodiment, the test pattern data PT may be transmitted to the receiving end 112 of the device under test 110 through the signal input end E1 and the signal output end E2. That is to say, the device under test 110 outputs and receives the test pattern data PT through a lookback mechanism under a high-speed signal transmission. During the transmission process from the transmitting end 111 to the receiving end 112, the test pattern data PT has been adjusted by the characteristic impedance Z0 and the variable impedance Zp.

The device under test 110 may generate a determining result R based on the test pattern data PT received from the receiving end 112. Specifically, the device under test 110 may determine whether the test pattern data PT received by the receiving end 112 and adjusted by the characteristic impedance Z0 and the variable impedance Zp is an acceptable data or unacceptable data, so as to generate and output the determining result R to the control circuit 120. For example, the test pattern data PT adjusted by the characteristic impedance Z0 and the variable impedance Zp is the acceptable data, which means that the attenuation of the current test environment meets the required specifications of the device under test 110. For example, the test pattern data PT adjusted by the characteristic impedance Z0 and the variable impedance Zp is an unacceptable data, which means that the attenuation of the current test environment does not meet the required specifications of the device under test 110. Therefore, the variable impedance Zp of the attenuation circuit 130 needs to be adjusted to facilitate subsequent testing operations.

The control circuit 120 may receive the determining result R, and generate an attenuation control signal CON to the adjustable attenuation circuit 130 based on the determining result R. In this embodiment, the determination result R is used to indicate whether the control circuit 120 needs to further adjust the variable impedance Zp of the adjustable attenuation circuit 130 and/or a value (or a range) of the required variable impedance Zp. The control circuit 120 may generate the attenuation control signal CON based on the determination result R to control the adjustable attenuation circuit 130 to adjust the variable impedance Zp.

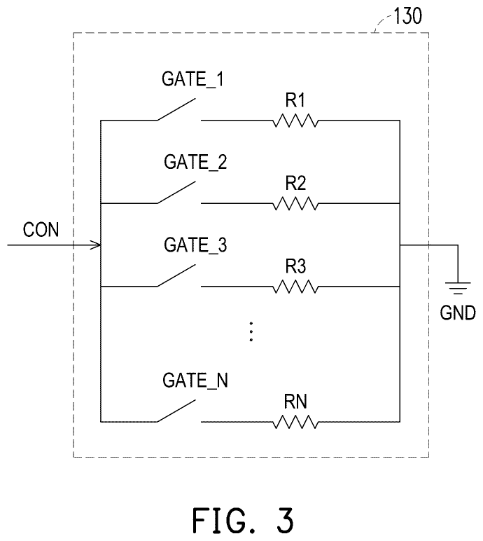

The adjustable attenuation circuit 130 may adjust the variable impedance Zp based on the attenuation control signal CON. Specifically, FIG. 3 is a schematic diagram of an adjustable attenuation circuit according to an embodiment of the disclosure. Referring to FIGS. 1 to 3, in this embodiment, the adjustable attenuation circuit 130 includes multiple resistors R1 to RN and multiple switches GATE_1 to GATE_N. The switches GATE_1 to GATE_N are respectively connected in series with the resistors R1 to RN.

The switches GATE_1 to GATE_N may be, for example, any form of microelectromechanical systems (MEMS) switches well known to those skilled in the art. In addition, the resistors R1 to RN may be, for example, any form of micro-resistors well known to those skilled in the art.

The switches GATE_1 to GATE_N may be turned on or off respectively based on the attenuation control signal CON. In this embodiment, the resistors R1 to RN have a difference of orders of magnitude from each other. For example, the resistance value of the resistor R1 is 0.1M ohm. The resistance value of the resistor R2 is 1M ohm. The resistance value of the resistor R3 is 10M ohm. The resistance value of the resistor RN is 100M ohm. The adjustable attenuation circuit 130 may turn on at least one of the switches GATE_1 to GATE_N based on the attenuation control signal CON to adjust the variable impedance Zp of the adjustable attenuation circuit 130.

In this way, the adjustable T-shaped attenuator 200 of the disclosure may adjust the variable impedance Zp based on the attenuation control signal CON to be adapted to the attenuation requirements of various devices under test 110 and provide a reliable electrical testing environment.

In addition, the test system 100 of the disclosure may also avoid the parasitic capacitance caused by the external environment by reducing component size (that is, using the MEMS switches GATE_1 to GATE_N and the micro-resistors R1 to RN) to eliminate an electrical interference to the greatest extent.

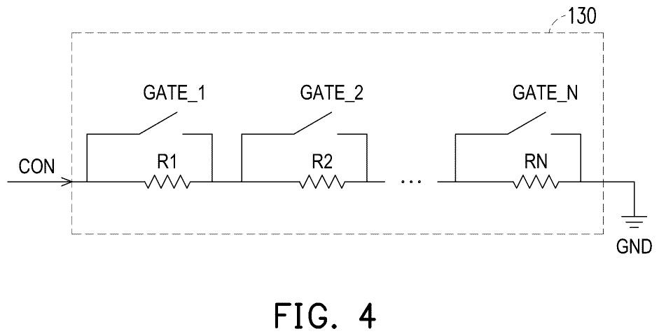

In an embodiment, the adjustable attenuation circuit 130 may also be shown in FIG. 4. FIG. 4 is a schematic diagram of an adjustable attenuation circuit according to another embodiment of the disclosure. Referring to FIG. 1 and FIG. 4, in this embodiment, the adjustable attenuation circuit 130 includes the resistors R1 to RN and the switches GATE_1 to GATE_N. The switches GATE_1 to GATE_N are respectively connected in parallel with the resistors R1 to RN.

The switches GATE_1 to GATE_N may be turned on or off respectively based on the attenuation control signal CON. Specifically, the adjustable attenuation circuit 130 may turn on at least one of the switches GATE_1 to GATE_N based on the attenuation control signal CON to adjust the variable impedance Zp of the adjustable attenuation circuit 130 to be adapted to the attenuation requirements of various devices under test 110.

Each micro-component in the adjustable attenuation circuit 130 may, for example, be connected in series and/or in parallel to provide multiple different attenuation levels.

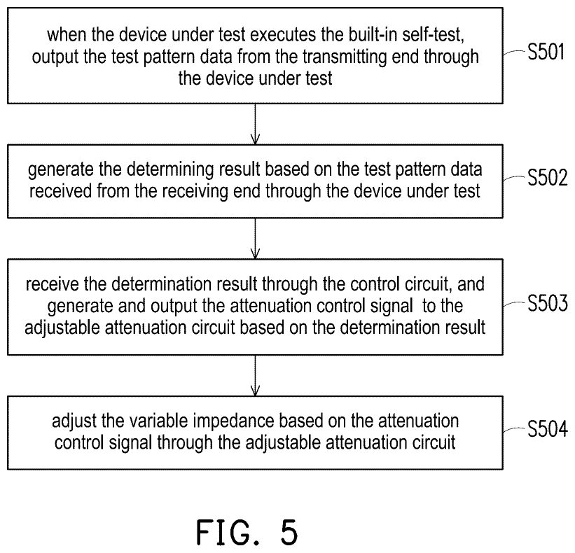

FIG. 5 is a flow chart illustrating an operation method of an adjustable attenuation test system according to an embodiment of the disclosure. The operation method of this embodiment may be executed by the test system 100 of FIG. 1. Referring to FIG. 1 and FIG. 5, in step S501, when the device under test 110 executes the built-in self-test, the test pattern data PT is output from the transmitting end 111 through the device under test 110. In step S502, the device under test 110 generates the determining result R based on the test pattern data PT received from the receiving end 112. In step S503, the determination result R is received through the control circuit 120, and the attenuation control signal CON is generated based on the determination result R to the adjustable attenuation circuit 130. In step S504, the variable impedance Zp is adjusted based on the attenuation control signal CON through the adjustable attenuation circuit 130.

The implementation details of the steps S501 to S504 have been described in detail in the foregoing embodiments and thus are not repeated herein.

To sum up, the adjustable attenuation test system and the operation method thereof provided by the disclosure may use the characteristic impedance of the substrate to replace the impedance at both ends of the conventional T-shaped attenuator, and complete the adjustment of the variable impedance through the lookback circuit design to be adapted to the attenuation requirements of various devices under test and provide the reliable electrical testing environment. In addition, the adjustable attenuation test system and the operation method thereof provided by the disclosure may also avoid the influence of the parasitic capacitance and the inductance effect caused by the external environment by reducing the component size (that is, using the microelectromechanical switches and the micro-resistors) to eliminated the electrical interference to the greatest extent.

What is claimed is:

1. An adjustable attenuation test system, comprising:
an adjustable attenuation circuit, having a variable impedance;
a control circuit; and
a device under test, connected to the adjustable attenuation circuit and the control circuit, wherein the device under test comprises:
a transmitting end; and
a receiving end, wherein
when the device under test executes a built-in self-test, the device under test outputs a test pattern data from the transmitting end, the device under test generates a determining result based on the test pattern data received from the receiving end,
the control circuit receives the determining result, and generates and outputs an attenuation control signal to the adjustable attenuation circuit based on the determining result,
the adjustable attenuation circuit adjusts the variable impedance based on the attenuation control signal.

2. The adjustable attenuation test system according to claim 1, wherein the adjustable attenuation circuit, a signal input end, and a signal output end form an adjustable T-shaped attenuator, the signal input end is connected to the transmitting end, and the signal output end is connected to the receiving end.

3. The adjustable attenuation test system according to claim 2, wherein the adjustable T-shaped attenuator is disposed on a substrate with a characteristic impedance.

4. The adjustable attenuation test system according to claim 1, wherein the adjustable attenuation circuit comprises:
a plurality of resistors; and
a plurality of switches, respectively connected in series with the plurality of resistors, wherein the plurality of switches are configured to be turned on or off respectively based on the attenuation control signal.

5. The adjustable attenuation test system according to claim 1, wherein the adjustable attenuation circuit comprises:
a plurality of resistors; and
a plurality of switches, respectively connected in parallel with the plurality of resistors, wherein the plurality of switches are configured to be turned on or off respectively based on the attenuation control signal.

6. The adjustable attenuation test system according to claim 4, wherein the plurality of switches are microelectromechanical systems (MEMS) switches.

7. The adjustable attenuation test system according to claim 4, wherein the plurality of resistors are micro-resistors, and the plurality of resistors have a difference of orders of magnitude from each other.

8. The adjustable attenuation test system according to claim 4, wherein the adjustable attenuation circuit turns on at least one of the plurality of switches based on the attenuation control signal to adjust the variable impedance of the adjustable attenuation circuit.

9. The adjustable attenuation test system according to claim 5, wherein the plurality of switches are microelectromechanical systems (MEMS) switches.

10. The adjustable attenuation test system according to claim 5, wherein the plurality of resistors are micro-resistors, and the plurality of resistors have a difference of orders of magnitude from each other.

11. The adjustable attenuation test system according to claim 5, wherein the adjustable attenuation circuit turns on at least one of the plurality of switches based on the attenuation control signal to adjust the variable impedance of the adjustable attenuation circuit.

12. An operation method of an adjustable attenuation test system, comprising:
outputting a test pattern data from a transmitting end through a device under test in response to the device under test executing a built-in self-test;
generating a determining result based on the test pattern data received from a receiving end through the device under test;
receiving the determining result through a control circuit, and generating and outputting an attenuation control signal to the adjustable attenuation circuit based on the determining result; and
adjusting a variable impedance based on the attenuation control signal through the adjustable attenuation circuit.

13. The operation method according to claim 12, wherein adjusting the variable impedance based on the attenuation control signal comprises:
turning on at least one of a plurality of switches in the adjustable attenuation circuit based on the attenuation control signal through the adjustable attenuation circuit to adjust the variable impedance of the adjustable attenuation circuit.
